(19) United States
(12) Patent Application Publication
(10) Pub. No.: US 2020/0171655 A1
(43) Pub. Date: Jun. 4, 2020

(54) AUTOMATIC CONTROL METHOD AND AUTOMATIC CONTROL DEVICE

(71) Applicant: Metal Industries Research & Development Centre, Kaohsiung (TW)

(72) Inventors: Shi-Wei Lin, Kaohsiung City (TW); Fu-I Chou, Kaohsiung City (TW); Chun-Ming Yang, Kaohsiung City (TW); Wei-Chan Weng, Kaohsiung City (TW); Chih-Chin Wen, Kaohsiung City (TW)

(73) Assignee: Metal Industries Research & Development Centre, Kaohsiung (TW)

(21) Appl. No.: 16/691,544

(22) Filed: Nov. 21, 2019

(30) Foreign Application Priority Data
Nov. 30, 2018 (TW) 107143035
Oct. 29, 2019 (TW) 108139026

(51) Int. Cl. B25J 9/16; G06K 9/00

(52) U.S. Cl. CPC B25J 9/163; B25J 9/1669; G06K 9/00671; G06K 9/00201; B25J 9/1664

(57) ABSTRACT

An automatic control method and an automatic control device are provided. The automatic control device includes a processing unit, a memory unit and a camera unit. The memory unit records an object database and a behavior database. When the automatic control device is operated in an automatic learning mode, the camera unit obtains a continuous image, and the processing unit analyzes the continuous image to determine whether there is an object being moved and matching an object model recorded in the object database in a first placement area. When the continuous image displays the object is moved, the processing unit obtain control data corresponding to moving the object from the first placement area to a second placement area, and the processing unit records the control data to the behavior database. The control data includes trajectory data and motion posture data of the object.

### CROSS-REFERENCE TO RELATED APPLICATION

This application claims the priority benefits of Taiwan application serial no. 107143035, filed on Nov. 30, 2018, and Taiwan application serial no. 108139026, filed on Oct. 29, 2019. The entirety of each of the above-mentioned patent applications is hereby incorporated by reference herein and made a part of this specification.

### BACKGROUND OF THE INVENTION

### 1. Field of the Invention

The present invention relates to an automatic control technology, and more particularly relates to an automatic control method and an automatic control device with a visual guidance function.

### 2. Description of Related Art

Since the current manufacturing industry is moving towards automation, a large number of robot arms are used in automated factories to replace manpower at present. However, for a traditional robot arm, an operator has to teach the robot arm to perform a specific action or posture through complicated point setting or programming. That is, the construction of the traditional robot arm has the disadvantages of slow arrangement and a demand for a large number of program codes, thus leading to extremely high construction cost of the robot arm. Hereto, solutions of several embodiments will be provided below to solve the problem of how to provide an automatic control device which can be quickly constructed and can accurately execute automatic control work.

### SUMMARY OF THE INVENTION

The present invention provides an automatic control method and an automatic control device which may provide an effective and convenient visual guidance function and accurately execute automatic control work.

An automatic control device of the present invention includes a processing unit, a memory unit and a camera unit. The memory unit is coupled to the processing unit, and is configured to record an object database and a behavior database. The camera unit is coupled to the processing unit. When the automatic control device is operated in an automatic learning mode, the camera unit is configured to obtain a plurality of continuous images and store the continuous images to a memory temporary storage area of the memory unit, and the processing unit analyzes the continuous image to determine whether an object matched with an object model recorded in the object database is moved in a first placement area. When the continuous images display the object is moved, the processing unit obtains a control data corresponding to the object being moved from the first placement area to a second placement area, and the processing unit records the control data to the behavior database, wherein the control data include motion track data and motion posture data of the object.

The following is a description that the automatic control device of the present invention is operated in an automatic learning mode.

In one embodiment of the present invention, when the automatic control device is operated in the automatic learning mode, and the processing unit determines that the object matched with the object model recorded in the object database is moved, the processing unit analyzes the continuous images recorded in the memory temporary storage area to determine whether a hand image or a holding device image capturing the object. When the continuous images appears the hand image or the holding device image grasping the object, the processing unit identifies a grasping action performed by the hand image or a holding device image on the object.

In one embodiment of the present invention, the control data further include grasping gesture data of the hand image or the holding device image. When the automatic control device is operated in the automatic learning mode, the camera unit records grasping action performed by the hand image or the holding device image on the object to obtain the grasping gesture data.

In one embodiment of the present invention, when the automatic control device is operated in the automatic learning mode, the processing unit records the hand image or the holding device image moving and placing the object from the first placement area to the second placement area by the camera unit to obtain the motion track data and the motion posture data of the object.

In one embodiment of the present invention, the control data include placement position data and placement posture data. When the automatic control device is operated in the automatic learning mode, the processing unit records the placement position data of the object placed in the second placement area and placement posture data of the object placed by the hand image or the holding device image in the second placement area by the camera unit.

In one embodiment of the present invention, the control data include environment characteristic data of the second placement area. When the automatic control device is operated in the automatic learning mode, the processing unit records the environment characteristic data of the second placement area by the camera unit.

The following is a description that the automatic control device of the present invention is operated in an automatic working mode.

In one embodiment of the present invention, when the automatic control device is operated in an automatic working mode, the camera unit is configured to obtain another plurality of continuous images and store the another continuous images to the memory temporary storage area of the memory unit, and the processing unit analyzes the another continuous images to determine whether the object matched with the object model recorded in the object database is placed in the first placement area. When the processing unit determines the object is placed in the first placement area, the processing unit reads the behavior database to obtain the control data corresponding to the object model, and the processing unit automatic control a robotic arm to grasp and move the object, so as to place the object to the second placement area.

In one embodiment of the present invention, when the automatic control device is operated in the automatic working mode, the processor operates the robotic arm to grasp the object according to the motion track data and the motion posture data of the object which is preset or modified and a grasping gesture data, and move to the second placement area.

In one embodiment of the present invention, when the automatic control device is operated in the automatic working mode, and after the robot arm grasps the object and moves to the second placement area, the processing unit operates the robotic arm to place the object in the second placement area according to placement position data and placement posture data.

In one embodiment of the present invention, when the automatic control device is operated in the automatic working mode, and after the robot arm grasps the object and moves to the second placement area, the processing unit further operates the robotic arm to place the object in the second placement area according to the environment characteristic data.

An automatic control method of the present invention is suitable for an automatic control device. The automatic control method includes the following steps: when an automatic control device is operated in an automatic learning mode, obtaining a plurality of continuous images by a camera unit, and storing the continuous images to a memory temporary storage area of a memory unit; analyzing the continuous image to determine whether an object matched with an object model recorded in an object database is moved in a first placement area by a processing unit; when the continuous images display the object is moved, obtaining a control data corresponding to the object being moved from the first placement area to a second placement area by the processing unit, wherein the control data include motion track data and motion posture data of the object; and recording the control data to a behavior database by the processing unit.

The following is a description of an automatic learning mode executed in the automatic control method of the present invention.

In one embodiment of the present invention, the automatic control method further includes the following steps: when the automatic control device is operated in the automatic learning mode, and determining that the object matched with the object model recorded in the object database is moved by the processing unit, analyzing the continuous images recorded in the memory temporary storage area by the processing unit to determine whether a hand image or a holding device image capturing the object; and when the continuous images appears the hand image or the holding device image grasping the object, identifying a grasping action performed by the hand image or a holding device image on the object by the processing unit.

In one embodiment of the present invention, the step of obtaining the control data corresponding to the object being moved from the first placement area to the second placement area by the processing unit includes: recording grasping action performed by the hand image or the holding device image on the object to obtain grasping gesture data by the camera unit, wherein the control data include the grasping gesture data of the hand image or the holding device image.

In one embodiment of the present invention, the step of obtaining the control data corresponding to the object being moved from the first placement area to the second placement area by the processing unit includes: recording the hand image or the holding device image moving and placing the object from the first placement area to the second placement area by the camera unit to obtain the motion track data and the motion posture data of the object.

In one embodiment of the present invention, the step of obtaining the control data corresponding to the object being moved from the first placement area to the second placement area by the processing unit includes: recording placement position data of the object placed in the second placement area and placement posture data of the object placed by the hand image or the holding device image in the second placement area by the camera unit, wherein the control data include the placement position data and the placement posture data.

In one embodiment of the present invention, the step of obtaining the control data corresponding to the object being moved from the first placement area to the second placement area by the processing unit includes: recording environment characteristic data of the second placement area by the camera unit, recording environment characteristic data of the second placement area by the camera unit.

The following is a description of the automatic working mode executed in the automatic control method of the present invention.

In one embodiment of the present invention, the automatic control method further includes the following steps: when the automatic control device is operated in an automatic working mode, obtaining another plurality of continuous images by the camera unit, and storing the another continuous images to the memory temporary storage area of the memory unit; analyzing the another continuous images to determine whether the object matched with the object model recorded in the object database is placed in the first placement area; when the processing unit determines the object is placed in the first placement area, reading the behavior database by the processing unit to obtain the control data corresponding to the object model; and automatic controlling a robotic arm to grasp and move the object by the processing unit, so as to place the object to the second placement area.

In one embodiment of the present invention, the step of automatic controlling the robotic arm to grasp and move the object by the processing unit, so as to place the object to the second placement area includes: operating the robotic arm to grasp the object according to the motion track data and the motion posture data of the object which is preset or modified and a grasping gesture data, and moving to the second placement area.

In one embodiment of the present invention, the step of operating a robot arm to grasp and move the object by the processing unit according to the control data, so as to place the object in the second placement area includes: operating the robotic arm by the processing unit to place the object in the second placement area according to placement position data and placement posture data.

In one embodiment of the present invention, the step of operating a robot arm to grasp and move the object by the processing unit according to the control data, so as to place the object in the second placement area further includes: further operating the robotic arm by the processing unit to place the object in the second placement area according to the environment characteristic data.

Based on the above, the automatic control device and automatic control method of the present invention may learn a specific gesture or behavior of a user for operating an object by means of visual guidance, and implement the same automatic control work or automatic control work that correspondingly operates the object by the robot arm.

In order to make the aforementioned features and advantages of the present invention more comprehensible, embodiments accompanied with figures are described in detail below.

### BRIEF DESCRIPTION OF THE DRAWINGS

FIG. 1 is a function block diagram of an automatic control device according to one embodiment of the present invention.

FIG. 2 is an operation schematic diagram of an automatic learning mode according to one embodiment of the present invention.

FIG. 3 is a flowchart of an automatic learning mode according to one embodiment of the present invention.

FIG. 4 is an operation schematic diagram of an automatic working mode according to one embodiment of the present invention.

FIG. 5 is a flowchart of an automatic working mode according to one embodiment of the present invention.

FIG. 6 is a flowchart of an automatic control method according to one embodiment of the present invention.

### DESCRIPTION OF THE EMBODIMENTS

In order to make the contents of the present invention easier and clearer, embodiments are illustrated below as examples that can be definitely implemented of the present invention. In addition, wherever possible, elements/structures/steps using the same numerals in the drawings and implementations refer to same or similar components.

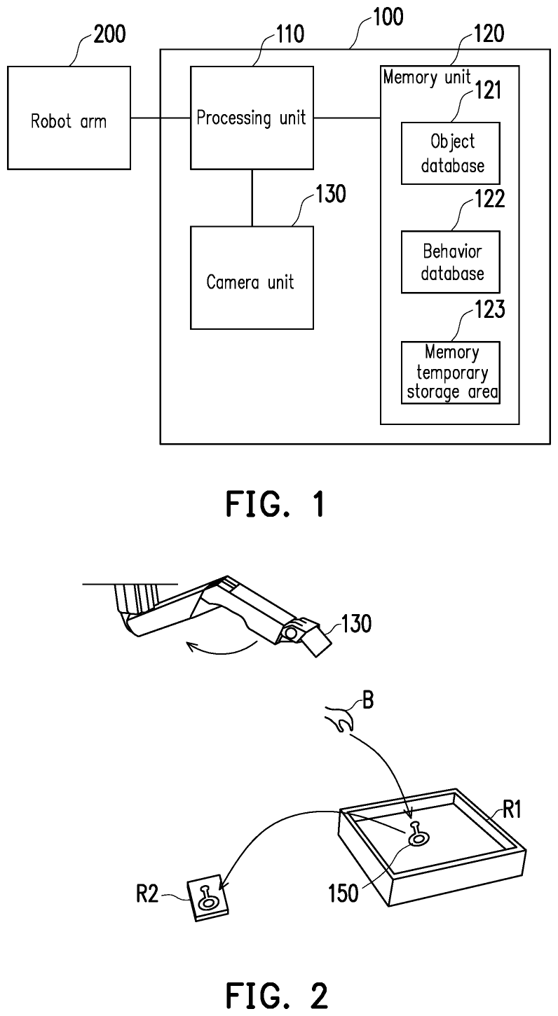

FIG. 1 is a function block diagram of an automatic control device according to one embodiment of the present invention. Referring to FIG. 1, an automatic control device 100 includes a processing unit 110, a memory unit 120 and a camera unit 130. The processing unit 110 is coupled to the memory unit 120 and the camera unit 130. In the present embodiment, the processing unit 110 may be further coupled to an external robot arm 200. In the present embodiment, the memory unit 120 is used to record an object database 121 and a behavior database 122, and has a memory temporary storage area 123. In the present embodiment, the automatic control device 100 may be operated in an automatic working mode and an automatic learning mode. Furthermore, the automatic control device 100 may control the robot arm 200 to execute automatic object movement work between two placement areas by automatic learning.

Moreover, it is worth mentioning that in the present embodiment, an operator may pre-build an object model for a working target object, or make archiving in the object database 121 by an input Computer Aided Design (CAD) model, so that the processing unit 110 may read the database and perform object comparison operation when subsequent object identification is performed in the automatic learning mode and the automatic working mode.

In the present embodiment, the processing unit 110 may be an Image Signal Processor (ISP), a Central Processing Unit (CPU), a microprocessor, a Digital Signal Processor (DSP), Programmable Logic Controller (PLC), an Application Specific Integrated Circuit (ASIC), a System on Chip (SoC), or other similar elements, or a combination of the above elements, and the present invention is not limited thereto.

In the present embodiment, the memory unit 120 may be a Dynamic Random Access Memory (DRAM), a flash memory or a Non-Volatile Random Access Memory (NVRAM), and the present invention is not limited thereto. The memory unit 120 may be used to record the databases, image data, control data and various control software etc. of the various embodiments of the present invention for reading and execution by the processing unit 110.

In the present embodiment, the robot arm 200 may be uniaxial or multiaxial, and may execute an object grasping action and postures of moving the object and the like. The automatic control device 100 communicates with the robot arm 200 in a wired or wireless manner, so as to automatically control the robot arm 200 to implement automatic learning modes and automatic working modes of the various embodiments of the present invention. In the present embodiment, the camera unit 130 may be an RGB-D camera, and may be used to simultaneously obtain two-dimensional image information and three-dimensional image information and provide the information to the processing unit 110 for image analysis operation such as image identification, depth measurement, object determination or hand identification, so as to implement the automatic working modes, the automatic learning modes and automatic control methods of various embodiments of the present invention. Moreover, in the present embodiment, the robot arm 200 and the camera unit 130 are mobile. Particularly, the camera unit 130 may be externally arranged on another robot arm or a transferable automatic robot device, and is operated by the processing unit 110 to automatically follow the robot arm 200 or a hand image in the embodiments below to perform relevant image acquisition operations.

FIG. 2 is an operation schematic diagram of an automatic learning mode according to one embodiment of the present invention. Referring to FIGS. 1 and 2, in the present embodiment, when the automatic control device 100 is operated in the automatic learning mode, the automatic control device 100 may obtain a plurality of continuous images of a first placement area R1 by the camera unit 130, and store to the memory temporary storage area 123. The processing unit 110 may analyze the continuous images to determine whether a hand image B appearing in the continuous images gets close to an object 150 placed in the first placement area R1. In the present embodiment, the processing unit 110 reads the object database 121 recorded in the memory unit 120, so as to determine whether there is a corresponding object model matched with the object 150 (meaning that the object 150 is a working target object). When the processing unit 110 determines that the object model in the object database 121 is matched with the object 150, the processing unit analyses the motion trajectory and the motion posture of the object 150 moved from the first placement area R1 to the second placement area R2 in the continuous images to obtain motion trajectory data and motion posture data corresponding to the object 150. Moreover, the processing unit 110 takes the motion trajectory data and the motion posture data as control data, and records them into the behavior database 122.

In addition, in one embodiment, the processing unit 110 may further identify the hand image B, so as to learn a posture of the hand image B. In other words, the automatic control device 100 of the one embodiment may automatically determine whether the object 150 exists at first, and then perform the hand identification. Therefore, in the automatic learning mode, the processing unit 110 may identify a grasping action executed by the hand image B on the object 150, so as to obtain corresponding control data, and record the control data into the behavior database 122.

However, the present invention is not limited to learning the behavior of the moving object 150 of the user's hand image B. In one embodiment, the object of the moving object 150 may also be realized by a holding device of a robotic arm. In other words, the processing unit 110 may analyze the continuous images to determine whether a holding device image is close to the object 150 placed in the first placement area R1 in the continuous images, and learn the posture of the holding device image to obtain the corresponding control data, and record the control data to the behavior database 122.

Specifically, when the processing unit 110 determines that the object 150 is placed in the first placement area R1, and the camera unit 130 shoots the hand image B (or a holding device image), firstly, the camera unit 130 follows the hand image B for image acquisition, so as to record postures of the hand image B (or the holding device image) for picking up and moving the object 150 and placing the object 150 in a second placement area R2. In the present embodiment, when the hand image B (or the holding device image) grasps and moves the object 150, the processing unit 110 may record a motion track and a motion posture of the object 150 and a grasping gesture of the hand image B (or the holding device image), so as to record motion track data and motion posture data of the object 150 and grasping gesture data of the grasping action performed by the hand image B (or the holding device image) into the behavior database 122 of the memory unit 120. Specifically, the motion track data and the motion posture data may include motion tracks and postures from the time after the hand image B (or the holding device image) grasps the object 150 and during the time when the hand image B (or the holding device image) moves and places the object 150 in the second placement area R2 till the time that the hand image B (or the holding device image) leaves the object 150. Then, when the hand image B (or the holding device image) grasps and moves the object 150, and the hand image B (or the holding device image) grasps the object 150 and moves to the second placement area R2, the processing unit 110 may record a placement position (for example, coordinates) of the second placement area R2 and a placement posture of the hand image B (or the holding device image) for placing the object 150 in the second placement area R2, so as to record placement position data and placement posture data into the behavior database 122 of the memory unit 120. Finally, the processing unit 110 may record environment characteristics (for example, the shape, appearance or surrounding conditions of the placement area) of the second placement area R2, so as to record environment characteristic data into the behavior database 122 of the memory unit 120. Therefore, the automatic control device 100 may execute the automatic working mode by reading the control data after completing recording the above control data.

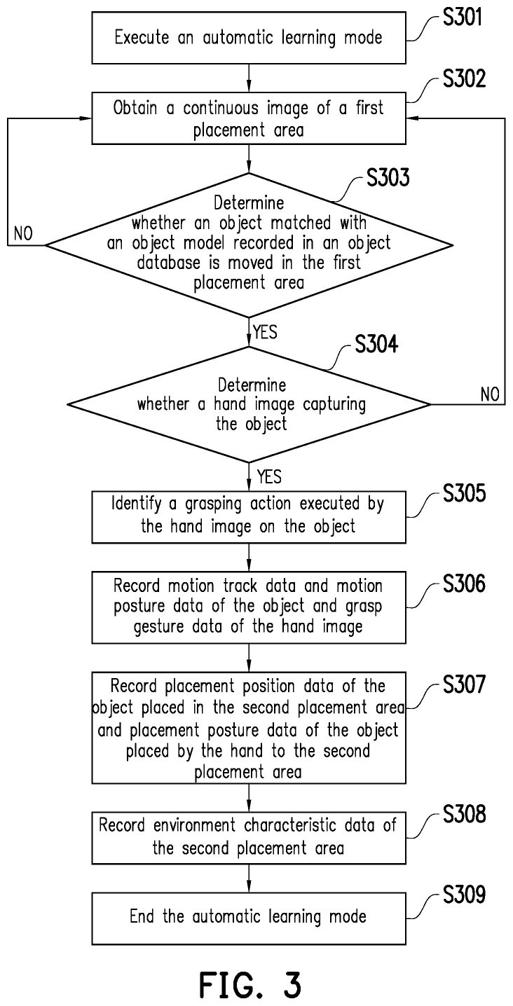

FIG. 3 is a flowchart of an automatic learning mode according to one embodiment of the present invention. Referring to FIGS. 1 to 3, the flow of the automatic learning mode of the present embodiment may be suitable for the automatic control device 100 of the embodiments of FIGS. 1 and 2. In Step S301, the automatic control device 100 executes the automatic learning mode. In Step S302, the camera unit 130 of the automatic control device 100 obtains continuous images of a first placement area R1. The continuous images may be stored in the memory temporary storage area 123. In Step S303, the processing unit 110 of the automatic control device 100 analyzes the continuous images of the first placement area R1 to determine whether an object matched with an object model recorded in an object database 121 is moved in a first placement area R1. If NO, the automatic control device 100 re-executes Step S302. If YES, the automatic control device 100 executes Step S304. In Step S304, the processing unit 110 of the automatic control device 100 further analyses the continuous images to determines whether a hand image B (or a holding device image) capturing the object 150. If NO, the automatic control device 100 re-executes Step S302. If YES, the automatic control device 100 executes Step S305. In Step S305, the processing unit 110 of the automatic control device 100 identifies grasping action performed by the hand image B (or the holding device image) on the object 150. In Step S306, the processing unit 110 of the automatic control device 100 records motion track data and motion posture data of the object 150 and grasping gesture data of the hand image B (or the holding device image). In Step S307, the processing unit 110 of the automatic control device 100 records placement position data of the object 150 placed in a second placement area R2 and placement posture data of the hand image B (or the holding device image) for placing the object 150 in the second placement area R2. In Step S308, the processing unit 110 of the automatic control device 100 may record environment characteristic data of the second placement area R2. In Step S309, the automatic control device 100 ends the automatic learning mode. Accordingly, the automatic control device 100 of the present embodiment may realize an automatic learning function in a visual way.

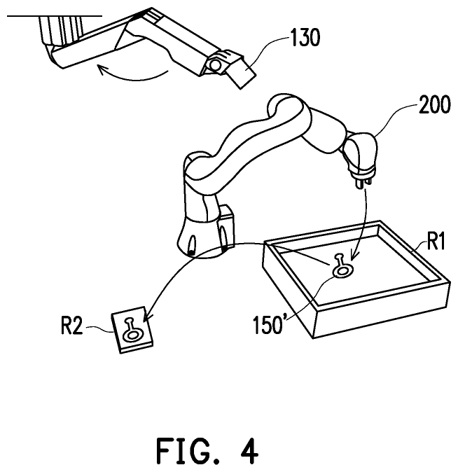

FIG. 4 is an operation schematic diagram of an automatic working mode according to one embodiment of the present invention. Referring to FIGS. 1 and 4, in the present embodiment, when the automatic control device 100 is operated in the automatic working mode, the automatic control device 100 may obtain continuous images of a first placement area R1 by the camera unit 130, and storing to the memory temporary storage area 123 of the memory unit 120. The processing unit 120 analyzes the continuous images, so as to determine whether an object 150′ is placed in the continuous images. In the present embodiment, the processing unit 110 reads the object database 121 recorded in the memory unit 120, so as to determine whether there is a corresponding object model matched with the object 150′. When the processing unit 110 determines that the object model in the object database 121 is matched with the object 150′, the processing unit 110 reads the behavior database 122 recorded in the memory unit 120, so as to read control data corresponding to the object model. Therefore, the processing unit 110 may operate the robot arm 200 to grasp and move the object 150′ placed in the first placement area R1 according to the control data, so as to place the object 150′ in a second placement area R2.

However, it is worth mentioning that the control data of the present embodiment may be relevant control data recorded when the automatic control device 100 of the embodiments of FIGS. 2 and 3 is operated in the automatic learning mode, but the present invention is not limited thereto.

Specifically, the processing unit 110 shoots the continuous images of the first placement area R1 by the camera unit 130, and determines whether the object 150′ matched with the object model recorded in the object database 121 is placed in the first placement area R1 in the continuous images. If YES, the processing unit 110 of the automatic control device 100 reads the behavior database 122, so as to obtain the control data corresponding to the object model (or corresponding to the object 150′). In the present embodiment, the control data may include motion track data and motion posture data of the object 150′, grasping gesture data of a hand image, placement position data, placement posture data and environment characteristic data, and the present invention is not limited thereto.

Further, firstly, the processing unit 110 operates the robot arm 200 to grasp the object 150′ according to motion track data and motion posture data which are preset or modified by the automatic learning mode and the grasping gesture data of the hand image. Then, the processing unit 110 operates the robot arm 200 to move the object 150′ to the second placement area R2 according to the placement position data and the placement posture data. Furthermore, in the present embodiment, the camera unit 130 may follow the robot arm 200 to move, so as to shoot continuous images of the second placement area R2. Finally, the processing unit 110 operates the robot arm 200 to place the object 150′ in the second placement area R2 according to the environment characteristic data. Therefore, the automatic control device 100 completes one automatic working task after completing the above actions, and the robot arm 200 may return to an original position, so as to continuously execute the same automatic working task for other working target objects having the same appearances as the object 150′ placed in the first placement area R1. Accordingly, the automatic control device 100 of the present embodiment may provide a high-reliability automatic working effect.

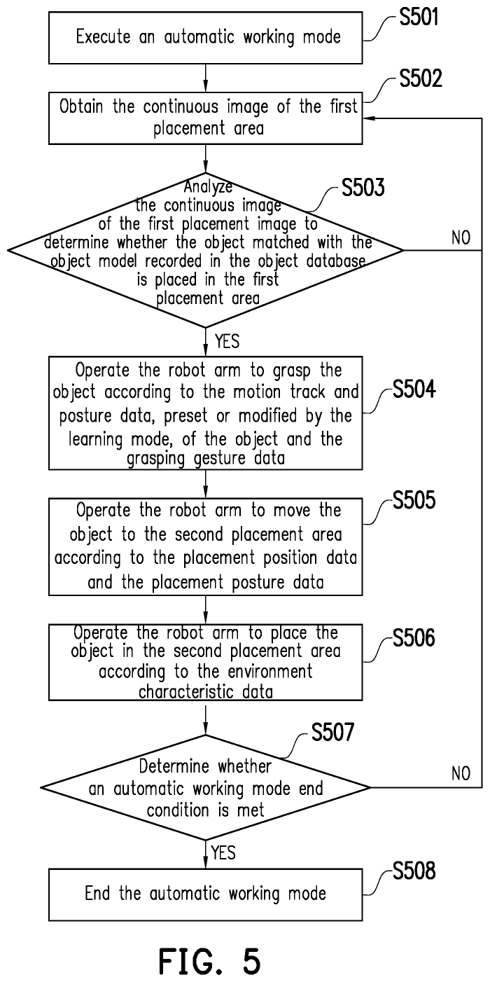

FIG. 5 is a flowchart of an automatic working mode according to one embodiment of the present invention. Referring to FIGS. 1, 4 and 5, the flow of the action learning mode of the present embodiment may be suitable for the automatic control device 100 of the embodiments of FIGS. 4 and 5. In Step S501, the automatic control device 100 executes the learning mode. In Step S502, the camera unit 130 of the automatic control device 100 obtains a continuous images of a first placement area R1. In Step S503, the automatic control device 100 analyzes the continuous images of the first placement area R1, so as to determine whether an object 150′ matched with an object model recorded in the object database 121 is placed in the first placement area R1. If NO, the automatic control device 100 re-executes Step S502. If YES, the automatic control device 100 executes Step S504. In Step S504, the processing unit 110 of the automatic control device 100 operates the robot arm 200 to grasp the object 150′ according to preset or modified motion track and posture data of the object and grasping gesture data. In Step S505, the processing unit 110 of the automatic control device 100 operates the robot arm 200 to move the object 150′ to a second placement area R2 according to placement position data and placement posture data. In Step S506, the processing unit 110 of the automatic control device 100 operates the robot arm 200 to place the object 150′ in the second placement area R2 according to environment characteristic data. In Step S507, the processing unit 110 of the automatic control device 100 determines whether an automatic working mode end condition is met. In the present embodiment, the automatic working mode end condition is, for example, the number of times of execution of the robot arm 200, or whether the object 150′ in the continuous images of the first placement area R1 does not exist, or whether a placement environment of the second placement area R2 is not suitable for continuous execution (for example, the second placement area R2 is full of a plurality of objects 150′). If NO, the processing unit 110 of the automatic control device 100 executes Step S502. If YES, the processing unit 110 of the automatic control device 100 executes Step S508, so as to end the automatic working mode. Accordingly, the automatic control device 100 of the present embodiment may realize a visual guidance function, and may accurately execute automatic control work.

It is worth mentioning that the continuous images in the above various embodiments mean that the camera unit 130 may continuously acquire images in the automatic learning mode and the automatic working mode. The camera unit 130 may immediately acquire the images, and the processing unit 110 may synchronously analyze the images, so as to obtain relevant data to automatically control the robot arm 200. In other words, a user may firstly execute the flow of the embodiment of FIG. 3 to execute the automatic learning mode, and then may continuously execute the flow of the embodiment of FIG. 5 to execute the automatic working mode.

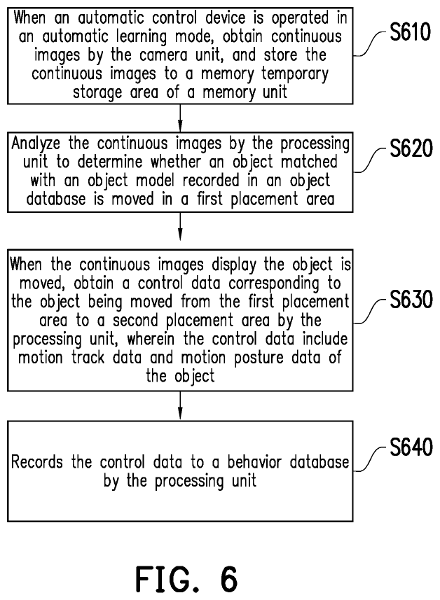

FIG. 6 is a flowchart of an automatic control method according to one embodiment of the present invention. Referring to FIGS. 1 and 6, the flow of the automatic control method of the present embodiment may be at least suitable for the automatic control device 100 of the embodiment of FIG. 1. In Step S610, when the automatic control device 100 is operated in an automatic learning mode, the automatic control device 100 obtains continuous images by the camera unit 130, and stores the continuous images to the memory temporary storage area 123 of the memory unit 120. In Step S620, the processing unit 110 analyzes the continuous images to determine whether an object matched with an object model recorded in the object database 121 is moved in a first placement area. In Step S630, when the continuous images display the object is moved, the processing unit 110 obtains a control data corresponding to the object being moved from the first placement area to a second placement area, wherein the control data include motion track data and motion posture data of the object. In Step S640, the processing unit 110 records the control data to the behavior database 122. Accordingly, the automatic control device 100 of the present embodiment may accurately execute automatic learning work.

In addition, sufficient teachings, suggestions and implementation descriptions of other element features, implementation details and technical features of the automatic control device 100 of the present embodiment may be obtained with reference to the descriptions of the above various embodiments of FIGS. 1 to 5, so that the descriptions thereof are omitted herein.

Based on the above, the automatic control device and the automatic control method of the present invention may firstly learn hand actions of an operator and behaviors of the operated object in the automatic learning mode to record relevant operation parameters and control data, and then automatically control the robot arm in the automatic working mode by means of the relevant operation parameters and control data obtained in the automatic learning mode, so that the robot arm may accurately execute the automatic control work. Therefore, the automatic control device and the automatic control method of the present invention may provide an effective and convenient visual guidance function and also provide a high-reliability automatic control effect.

Although the present invention has been disclosed by the embodiments above, the embodiments are not intended to limit the present invention, and any one of ordinary skill in the art can make some changes and embellishments without departing from the spirit and scope of the present invention. Therefore, the protection scope of the present invention is defined by the scope of the attached claims.

What is claimed is:

1. An automatic control device, comprising:
a processing unit;
a memory unit, coupled to the processing unit, and configured to record an object database and a behavior database; and
a camera unit, coupled to the processing unit,
wherein when the automatic control device is operated in an automatic learning mode, the camera unit is configured to obtain a plurality of continuous images and store the continuous images to a memory temporary storage area of the memory unit, and the processing unit analyzes the continuous image to determine whether an object matched with an object model recorded in the object database is moved in a first placement area,
wherein when the continuous images display the object is moved, the processing unit obtains a control data corresponding to the object being moved from the first placement area to a second placement area, and the processing unit records the control data to the behavior database, wherein the control data comprise motion track data and motion posture data of the object.

2. The automatic control device according to claim 1, wherein when the automatic control device is operated in the automatic learning mode, and the processing unit determines that the object matched with the object model recorded in the object database is moved, the processing unit analyzes the continuous images recorded in the memory temporary storage area to determine whether a hand image or a holding device image capturing the object, and when the continuous images appears the hand image or the holding device image grasping the object, the processing unit identifies a grasping action performed by the hand image or a holding device image on the object.

3. The automatic control device according to claim 2, wherein the control data further comprise grasping gesture data of the hand image or the holding device image,
when the automatic control device is operated in the automatic learning mode, the camera unit records grasping action performed by the hand image or the holding device image on the object to obtain the grasping gesture data.

4. The automatic control device according to claim 2, wherein when the automatic control device is operated in the automatic learning mode, the processing unit records the hand image or the holding device image moving and placing the object from the first placement area to the second placement area by the camera unit to obtain the motion track data and the motion posture data of the object.

5. The automatic control device according to claim 2, wherein the control data comprise placement position data and placement posture data,
when the automatic control device is operated in the automatic learning mode, the processing unit records the placement position data of the object placed in the second placement area and placement posture data of the object placed by the hand image or the holding device image in the second placement area by the camera unit.

6. The automatic control device according to claim 1, wherein the control data comprise environment characteristic data of the second placement area,
when the automatic control device is operated in the automatic learning mode, the processing unit records the environment characteristic data of the second placement area by the camera unit.

7. The automatic control device according to claim 6, wherein when the automatic control device is operated in an automatic working mode, the camera unit is configured to obtain another plurality of continuous images and store the another continuous images to the memory temporary storage area of the memory unit, and the processing unit analyzes the another continuous images to determine whether the object matched with the object model recorded in the object database is placed in the first placement area,
wherein when the processing unit determines the object is placed in the first placement area, the processing unit reads the behavior database to obtain the control data corresponding to the object model, and the processing unit automatic control a robotic arm to grasp and move the object, so as to place the object to the second placement area.

8. The automatic control device according to claim 7, wherein when the automatic control device is operated in the automatic working mode, the processor operates the robotic arm to grasp the object according to the motion track data and the motion posture data of the object which is preset or modified and a grasping gesture data, and move to the second placement area.

9. The automatic control device according to claim 7, wherein when the automatic control device is operated in the automatic working mode, and after the robot arm grasps the object and moves to the second placement area, the processing unit operates the robotic arm to place the object in the second placement area according to placement position data and placement posture data.

10. The automatic control device according to claim 9, wherein when the automatic control device is operated in the automatic working mode, and after the robot arm grasps the object and moves to the second placement area, the processing unit further operates the robotic arm to place the object in the second placement area according to the environment characteristic data.

11. An automatic control method suitable for an automatic control device, wherein the automatic control method comprises:
when an automatic control device is operated in an automatic learning mode, obtaining a plurality of continuous images by a camera unit, and storing the continuous images to a memory temporary storage area of a memory unit;
analyzing the continuous image to determine whether an object matched with an object model recorded in an object database is moved in a first placement area by a processing unit;
when the continuous images display the object is moved, obtaining a control data corresponding to the object being moved from the first placement area to a second placement area by the processing unit, wherein the control data comprise motion track data and motion posture data of the object; and
recording the control data to a behavior database by the processing unit.

12. The automatic control method according to claim 11, further comprising:
when the automatic control device is operated in the automatic learning mode, and determining that the object matched with the object model recorded in the object database is moved by the processing unit, analyzing the continuous images recorded in the memory temporary storage area by the processing unit to determine whether a hand image or a holding device image capturing the object; and
when the continuous images appears the hand image or the holding device image grasping the object, identifying a grasping action performed by the hand image or a holding device image on the object by the processing unit.

13. The automatic control method according to claim 12, wherein the step of obtaining the control data corresponding to the object being moved from the first placement area to the second placement area by the processing unit comprises:
recording grasping action performed by the hand image or the holding device image on the object to obtain grasping gesture data by the camera unit, wherein the control data comprise the grasping gesture data of the hand image or the holding device image.

14. The automatic control method according to claim 12, wherein the step of obtaining the control data corresponding to the object being moved from the first placement area to the second placement area by the processing unit comprises:
recording the hand image or the holding device image moving and placing the object from the first placement area to the second placement area by the camera unit to obtain the motion track data and the motion posture data of the object.

15. The automatic control method according to claim 12, wherein the step of obtaining the control data corresponding to the object being moved from the first placement area to the second placement area by the processing unit comprises:
recording placement position data of the object placed in the second placement area and placement posture data of the object placed by the hand image or the holding device image in the second placement area by the camera unit,
wherein the control data comprise the placement position data and the placement posture data.

16. The automatic control method according to claim 11, wherein the step of obtaining the control data corresponding to the object being moved from the first placement area to the second placement area by the processing unit comprises:
recording environment characteristic data of the second placement area by the camera unit,
wherein the control data comprise environment characteristic data of the second placement area.

17. The automatic control method according to claim 11, further comprising:
when the automatic control device is operated in an automatic working mode, obtaining another plurality of continuous images by the camera unit, and storing the another continuous images to the memory temporary storage area of the memory unit;
analyzing the another continuous images to determine whether the object matched with the object model recorded in the object database is placed in the first placement area;
when the processing unit determines the object is placed in the first placement area, reading the behavior database by the processing unit to obtain the control data corresponding to the object model; and
automatic controlling a robotic arm to grasp and move the object by the processing unit, so as to place the object to the second placement area.

18. The automatic control method according to claim 17, wherein the step of automatic controlling the robotic arm to grasp and move the object by the processing unit, so as to place the object to the second placement area comprises:
operating the robotic arm to grasp the object according to the motion track data and the motion posture data of the object which is preset or modified and a grasping gesture data, and moving to the second placement area.

19. The automatic control method according to claim 17, wherein the step of operating a robot arm to grasp and move the object by the processing unit according to the control data, so as to place the object in the second placement area comprises:
operating the robotic arm by the processing unit to place the object in the second placement area according to placement position data and placement posture data.

20. The automatic control method according to claim 19, wherein the step of operating a robot arm to grasp and move the object by the processing unit according to the control data, so as to place the object in the second placement area further comprises:
further operating the robotic arm by the processing unit to place the object in the second placement area according to the environment characteristic data.
